(19) United States
(12) Patent Application Publication
(10) Pub. No.: US 2026/0105926 A1
(43) Pub. Date: Apr. 16, 2026

(54) METHOD AND SYSTEM FOR RECONSTRUCTING SPEECH SIGNALS

(71) Applicant: Harman International Industries, Incorporated, Stamford, CT (US)

(72) Inventors: Ruiting YANG, Shenzhen (CN); Yueyang GUAN, Shenzhen (CN); Songcun CHEN, Shenzhen (CN); Xiang DENG, Shenzhen (CN)

(73) Assignee: Harman International Industries, Incorporated, Stamford, CT (US)

(21) Appl. No.: 18/914,681

(22) Filed: Oct. 14, 2024

(51) Int. Cl. G10L 19/087; G10L 21/0216

(52) U.S. Cl. CPC G10L 19/087; G10L 21/0216

(57) ABSTRACT

The disclosure relates to a method and system for reconstructing speech signals. The method may estimate a transfer function between an in-air speech signal outputted from at least one in-air sensor and an in-ear speech signal outputted from at least one in-ear sensor, and obtain an estimated speech signal based on the estimated transfer function and the in-ear speech signal. The method may further perform an excitation expansion on the estimated speech signal to obtain a first estimated excitation signal, and reconstruct a speech signal based on the first estimated excitation signal.

### CROSS-REFERENCE TO RELATED APPLICATIONS

This application is a continuation of International Application No. PCT/CN2022/086584, filed on Apr. 13, 2022. The disclosure of the above application is incorporated herein by reference.

### FIELD

The present disclosure relates to a speech enhancement, and specifically relates to a method and system for reconstructing speech signals by enhancing spectrums of signals captured by at least one in-ear sensor.

### BACKGROUND

The statements in this section merely provide background information related to the present disclosure and may not constitute prior art.

With the continuous development of headset devices and related technologies, the headset devices have been widely used in a voice communication between users. Usually, in a quiet or high signal to noise ratio (SNR) environment, an in-air sensor of the headset device captures speech signals with high quality and intelligibility, and the captured speech signals are often used for further processing. However, in a noisy environment, the input of the in-air audio sensor of the headset device could be dominated by heavy noises. For example, in a strong wind field or in the terrible noisy environments such as factories, disaster rescue, war field, etc., the captured speech signals are severely contaminated and in a very low quality, even fully loss the intelligibility. An audio sensor plugged in ear (i.e., an in-ear audio sensor) can isolate the noise naturally, thus in-ear signals captured by the in-ear audio sensor may be used for communication. However, speech signals captured by the in-ear audio sensor have some distortions and lack high frequency components. Thus, the voice sounds muffled and uncomfortable.

Therefore, it is desired to develop an improved approach to overcome the above defects and thus provide a better auditory experience to the user at a far end of the communication to improve the quality of the voice communication in a noisy environment.

### SUMMARY

This section provides a general summary of the disclosure and is not a comprehensive disclosure of its full scope or all of its features.

According to one aspect of the disclosure, a method for reconstructing speech signals is provided. The method may estimate a transfer function between an in-air speech signal and an in-ear speech signal, and obtain an estimated speech signal based on the estimated transfer function and the in-ear speech signal. The method may further perform an excitation expansion on the estimated speech signal to obtain a first estimated excitation signal, and reconstruct a speech signal based on the first estimated excitation signal.

According to another aspect of the present disclosure, a system for reconstructing speech signals is provided. The system may comprise at least one in-air sensor, at least one in-ear sensor, and a processor coupled to the at least one in-air sensor and the at least one in-ear sensor. The processor may be configured to estimate a transfer function between an in-air speech signal outputted from the at least one in-air sensor and an in-ear speech signal outputted from the at least one in-ear sensor, and obtain an estimated speech signal based on the estimated transfer function and the in-ear speech signal. The processor may further perform an excitation expansion on the estimated speech signal to obtain a first estimated excitation signal, and reconstruct a speech signal based on the first estimated excitation signal.

According to yet another aspect of the present disclosure, a non-transitory computer-readable storage medium comprising computer-executable instructions is provided which, when executed by a computer, causes the computer to perform the method disclosed herein.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example of a cutaway view of a headset device equipped with both in-air and in-ear sensors according to one or more embodiments of the present disclosure;

FIG. 2 illustrates a flowchart of the method for reconstructing the speech signal according to one or more embodiments of the present disclosure;

FIG. 3 illustrates an example of a clean voiced vowel captured by an in-air microphone and an in-ear microphone;

FIG. 4 illustrates a diagram of estimating the transfer function between the speech signal received by in-air and in-ear microphones according to one or more embodiments of the present disclosure;

FIG. 5 illustrates an example of the estimated transfer functions between the in-ear and in-air microphones for male and female according to one or more embodiments of the present disclosure;

FIG. 6 illustrates an example of spectrums of a section of an in-air signal, an in-ear signal, and an estimated speech signal in a quiet case according to one or more embodiments of the present disclosure;

FIG. 7 illustrates an example of spectrums of a section of an in-air signal, an in-ear signal, and an estimated speech signal in a wind noise case according to one or more embodiments of the present disclosure;

FIG. 8 illustrates a flowchart of the method for performing the excitation expansion on the estimated speech signal according to one or more embodiments of the present disclosure;

FIG. 9 illustrates a flowchart of the method for performing the first processing at S802 of FIG. 8 according to one or more embodiments of the present disclosure;

FIG. 10 illustrates a flowchart of the method for performing the second processing at S804 of FIG. 8 according to one or more embodiments of the present disclosure;

FIG. 11 illustrates a flowchart of a method for synthesizing or reconstructing the speech signal based on the first estimated excitation according to one or more embodiments of the present disclosure;

FIG. 12 illustrates a flowchart of another method for synthesizing or reconstructing the speech signal based on the first estimated excitation according to one or more embodiments of the present disclosure;

FIG. 13 illustrates examples of spectrums of a section of an in-air signal, an in-ear signal and a reconstructed speech signal in a wind noise case, using the method according to one or more embodiments of the present disclosure; and

FIG. 14 illustrates an example of a system for reconstructing speech signals according to one or more embodiments of the present disclosure.

It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Examples will be provided below for illustration. The descriptions of the various examples will be presented for purposes of illustration, but are not intended to be exhaustive or limited to the embodiments disclosed. Many modifications and variations will be apparent to those of ordinary skill in the art without departing from the scope and spirit of the described embodiments.

To improve a dilemma of a communication in some heavy noise cases, the present disclosure provides a method and system for reconstructing speech signals by enhancing the spectrums of signals captured by at least one in-ear sensor for example, in a headset device. Specifically, the method and the system disclosed herein aim to improve the quality of the speech signals captured by the in-ear sensor and provide a better auditory experience to the user at a far end of a voice communication, by compensating an energy loss in low and median frequency bands and enhancing harmonics of speech signals in high frequency bands.

For example, for a headset device mounted with both in-air and in-ear audio sensors, a transfer function between speech signals from these sensors can be estimated. The transfer function can compensate the difference between the two different pathways from a wearer's human vocal system to the sensors. The method and system may compensate a spectral envelope loss in the low-median frequency band through the estimated transfer function. Furthermore, the method and system may produce artificial speech excitation in median and high frequency bands by modulating the signal in a low frequency band to higher frequency bands, and merges glottal/vocal filters estimated from signals captured by both in-ear and in-air audio sensors, to synthesis a speech signal. The proposed approach herein is a new method with low complexity. It is different from those methods for bandwidth expansion in the telecommunication community, which require extensive training/computation for code book mapping or deep learning methods. The proposed method and system will be explained in details referring to FIGS. 1-14 as follows.

FIG. 1 illustrates an example of a cutaway view of a headset device equipped with both in-air and in-ear audio sensors (such as microphones) according to one or more embodiments of the present disclosure. For simplicity, FIG. 1 only shows one in-air audio sensor (microphone) 101 and one in-ear audio sensor (microphone) 102. It can be recognized that the headset device may include at least one in-air microphone and at least one in-ear microphone, and the appearance of the headset device may be different from that shown in FIG. 1.

It is well known that the human speech phonemes are voiced or unvoiced, where a voiced speech is a composition of a series of harmonics and an unvoiced speech is mainly aperiodic. The mechanism of speech generation can be simplified as a source and filter model.

The source is usually the air flow from lungs, which is pushed and passes the vocal folds and glottis when people breathe, speak or sing. With different air pressure and tension, the glottis is fully or near to open for breathing and producing unvoiced sounds, while it is squeezed during producing voiced vowels or singing, and the vocal folds vibrate at a certain frequency and an oscillation occurs in the larynx. Then, the air flow goes through the vocal tract, which is from the larynx to the lips and in different average length for male and female, adult and children, and eventually becomes speech phonemes. The modulation process in the vocal tract is modelled as the filtering process, where the filter varies for different phonemes even varies among each individual.

Every human voiced speech phoneme (vowel) owns a harmonic structure. The voice harmonics are produced in two primary ways: by collision of the vocal folds and by acoustic energy from the vocal tract being fed back to the glottis and altering the glottal flow. Simply, it produces a distortion of a glottal airflow at a single frequency, i.e., the fundamental. Thus, the harmonics are generated at the frequencies near to the multiple times of the fundamental frequency (F0). Although some Doppler effect in the process of propagation would happens, it only causes a slightly shift in frequency. Therefore, it is possible to estimate the frequencies of all the harmonics, in case some frequency bands are missing or contaminated. Furthermore, if a spectral envelope is known, the voiced speech signals in any frequency bands could be estimated.

Speech signals captured by an in-air audio sensor, such as an in-air microphone, are usually in good quality, but some strong noise could contaminate it severely. Even with the noise suppression in time-frequency-spatial domains, the signals might be still unsatisfactory.

Noises are usually independent to speech signals and most energy of the noise is in low frequency bands. Additionally, noise sources are normally further than the distance from a wearer's mouth to the headset device (or the wearer's ear). Thus, the energy in higher frequencies is attenuated quicker during propagation. For example, wind noises or punch noises from a factory environment, hurt the low frequency band of a speech signal badly, but affect much lighter to the high frequency of the speech signal. In these cases, the headset wearer would normally speak loudly. Although the low frequency part of the speech can be completely damaged, the spectral envelope in high frequency band is mainly some lifted by the noise but still keeps the shape of the spectral envelope.

In-ear sensors (e.g., in-ear microphones) are often used in devices, such as headset devices with Active Noise Cancelling (ANC) function. The in-ear microphone can provide a good chance to detect the human speech signals, as it is plugged in the ear and well isolates noises from the environment, thus generally captures the speech signals with a high signal to noise ratio (SNR). However, due to the propagation in bone and tissue, the captured speech signals are mainly in a frequency band below 2500 Hz and the energy of speech signals drops significant as the frequency increases. Additionally the speech sound could go through Eustachian tube, which is a small passageway that connects throat to middle ear, which allows unvoiced speech signals to propagate through but with a very weak intensity. Thus, speech signals captured by an in-ear sensor are strong in low frequency and become weak as the frequency increases, and sound muffled and unnatural.

In one form, speech signals captured by in-air sensors are considered as speech signals are sounds people are accustomed to. Therefore, the disclosure proposes an approach for reconstructing the speech signal captured by an in-ear audio sensor, so that the reconstructed speech signal may be close to the in-air sound.

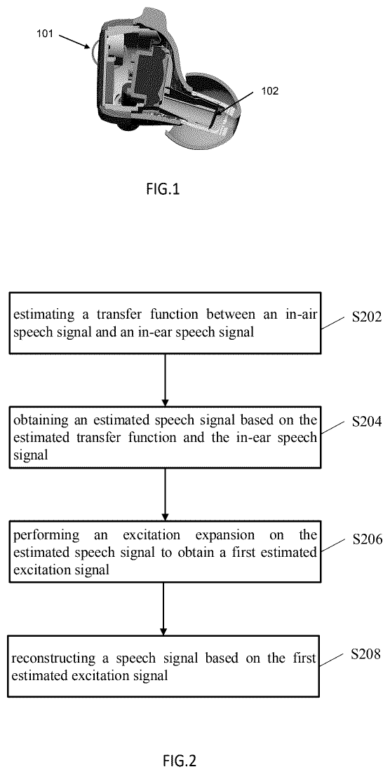

FIG. 2 illustrates a flowchart of the method for reconstructing the speech signal according to one or more embodiments of the present disclosure. At S202, a transfer function between an in-air speech signal and an in-ear speech signal may be estimated. The in-air speech signal may be a signal outputted from one in-air sensor, or may be a signal obtained by combining signals from multiple in-air sensors. Likewise, the in-ear speech signal may be a signal outputted from one in-ear sensor, or may be a signal obtained by combining signals from multiple in-ear sensors.

At S204, based on the estimated transfer function and the in-ear speech signal, an estimated speech signal may be obtained. At S206, an excitation expansion may be performed on the estimated speech signal obtained at S204, and then an estimated excitation signal associated with the in-ear speech signal may be generated. At S208, a speech signal may be reconstructed based on the estimated excitation signal.

The method illustrated in FIG. 2 may compensate the in-ear signal with a transfer function to equalize the difference between two propagation pathways, which mainly enhances the low and median frequency, for example, mainly below 3000 Hz. Additionally, the method may enhance the harmonics in higher frequency bands in the bandwidth expansion way.

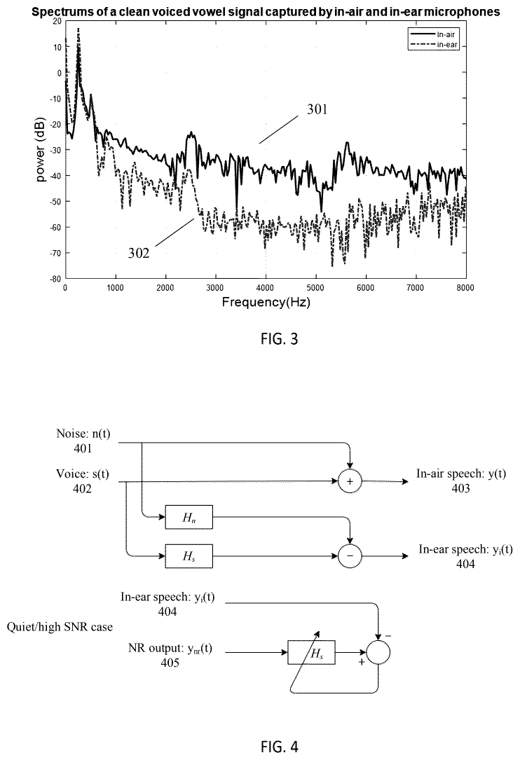

Next, the transfer function between speech signals captured by in-air and in-ear microphones will be described in references to FIGS. 3-6.

The signal received by the in-ear microphone may be somewhat different from the signal received by the in-air microphone in spectrum, as its propagation is different from the in-air pathway (from the mouth to the device). An example of a clean voiced vowel captured by an in-air microphone and an in-ear microphone are showed in FIG. 3, where their spectrums are plotted as two curves, respectively. For example, the curve 301 indicates the spectrum of the clean voiced vowel captured by the in-air microphone, and the curve 302 indicates the spectrum of the clean voiced vowel captured by the in-ear microphone. Comparing with the air-conducted speech signal, the speech signal received by the in-ear microphone (also referred to below as the in-ear signal or the in-ear speech signal) has a stronger DC/very low frequency band (below 200 Hz). The in-ear signal is highly correlated with the speech signal captured by the in-air microphone (also referred to below as the in-air signal or the in-air speech signal), but its amplitude is gradually reduced in the frequency band below 800 Hz. The loss (difference) is steady increased versus frequencies in 800-2500 Hz, but the in-ear signal is still highly correlated with the in-air signal. The in-ear signal is weak in the band between 2500 and 5000 Hz. The loss becomes significant with the frequency increases, but the in-ear signal is still partly correlated with the in-air signal. The in-ear signal above 5000 Hz is somewhat like noise, and the correlation between the in-ear signal and the in-air signal is weak.

The model of both a noise signal n(t) 401 and a speech signal s(t) 402 propagating and being received by the device (including both in-air and in-ear audio sensors) is depicted in FIG. 4. There is one transfer function Hₙ which describes the device's isolation effect to the noise, while the other one, i.e., the transfer function Hₛ, represents the difference between two propagation pathways of a device wearer's speech signals. The outputs of two propagating paths are an in-air speech signal (noisy speech) y(t) 403 and an in-ear speech signal yᵢ(t) 404. This transfer function Hₛ may be estimated in an adaptive filtering way by going through a large amount of data either in a quiet condition or a high SNR case with an effective noise suppression. The process of adaptively estimating the transfer function is also described in FIG. 4. The NR output, yₙᵣ(t) 405, represents an output of the in-air speech y(t) 403 after noise reduction processing.

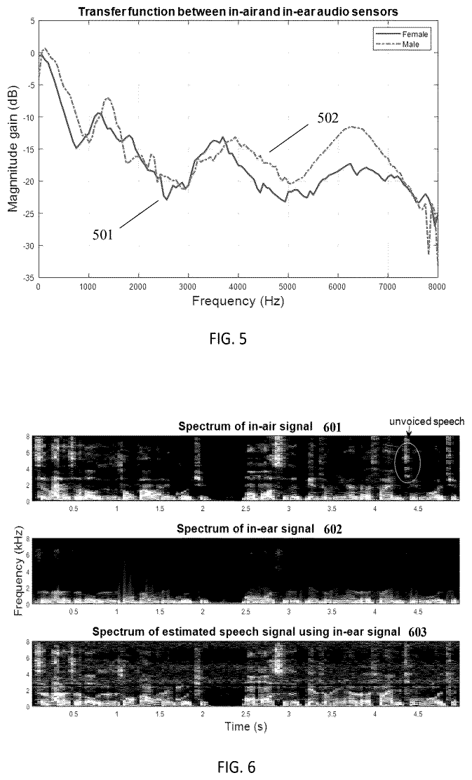

According to one or more embodiments, the transfer function may be pre-estimated using recorded data in quiet case, where it is considered that the signal captured by the in-air sensor is near to the same as the pure voice signal, s(t). For example, the estimated transfer functions between the in-ear and in-air sensors for male and female are generated separately and plotted in FIG. 5. In FIG. 5, the curve 501 indicates the transfer function between the in-ear and in-air sensors for female, and the curve 502 indicates the transfer function between the in-ear and in-air sensors for male.

According to one or more embodiments, one of the transfer functions for female and male templates may be selected as a pre-estimated transfer function. The two transfer functions as examples shown in FIG. 5 are only used as the basic templates for each case. In practice use, it is unknown or unsophisticated to choose from the gender of a wearer. For example, the selection between the two templates may be made by estimating a loudness and a spectral centroid of a section of speech with a high SNR.

According to another one or more embodiments, the transfer function may be adaptively updated. For example, one transfer function may be selected from the basic templates as an initial transfer function, and then it may be further updated to fit each individual wearer once the quiet or high SNR environment occurs.

The transfer function may be used to obtain the estimated in-ear signal from the in-air microphone and obtain an estimated speech signal using the in-ear signal.

For example, the estimated in-ear signal calculated from the in-air microphone is given by

$${\hat{y}}_{i} ( t ) = y ( t ) * h ( t ) , \qquad ( 1 )$$

where y(t) and h(t) are the in-air signal and an impulse response of Hₛ in a time domain.

For example, the estimated speech signal calculated from the in-ear signal is given by

$$\hat{s} ( t ) = {y}_{i} ( t ) * g ( t ) , \qquad ( 2 )$$

where yᵢ(t) and g(t) are the in-ear signal and an impulse response of an inverse of the transfer function of Hₛ in the time domain.

In quiet cases, the estimated speech signal calculated based on the transfer function and the in-ear signal is very close to the in-air signal. Also, the Eustachian tube allows the weak unvoiced speech signal to pass to the ear, and the transfer function enhances it as well. FIG. 6 illustrates an example of spectrums 601, 602 and 603 of a section of an in-air signal y(t), an in-ear signal yᵢ(t), and an estimated speech signal ŝ(t) in a quiet case according to one or more embodiments. It can be seen from FIG. 6, due to the processing via the transfer function, the estimated speech signal calculated from the in-ear signal is similar to the speech signal captured by the in-air microphone (i.e., the in-air signal). Even unvoiced speech phonemes can be recovered quite well. For example, an unvoiced speech phoneme is circled in FIG. 6.

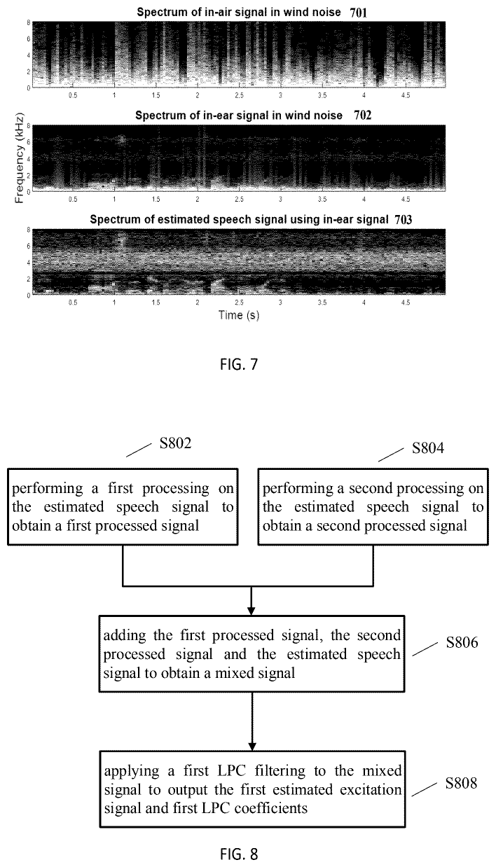

It can be further noticed from FIG. 6, for example, some background noises above 2500 Hz are also amplified, which can be potentially removed easily in further processing. However, in a noisy case, some non-stationary noises may leak into the in-ear microphone. The performance of the above method would be degraded, because the transfer function also amplifies noises and causes contamination to the speech signal. FIG. 7 illustrates an example of spectrums 701, 702 and 703 of a section of an in-air signal y(t), an in-ear signal yᵢ(t) and an estimated speech signal s(t) in a wind noise case. For example, the wind noise case is that the same subject as FIG. 6 talked in a windy environment with a strong wind at a speed of 3 m/s. It can be seen from FIG. 7 that the estimated speech signal calculated based on the transfer function and the in-ear signal contains very strong noises above 2500 Hz, and the high frequency part of the speech signal could not be recovered well.

In this noisy case, although noise suppression may be applied to remove the leaked noise, it is difficult to suppress all types of noises very well. Also, as the components above 2500 Hz of speech signals captured by the in-ear audio sensor are weak, common noise suppression methods would easily attenuate/hurt the speech signals in this frequency band. Thus, only applying the transfer function to the in-ear signal after the noise suppression could not provide satisfactory results in a noisy environment.

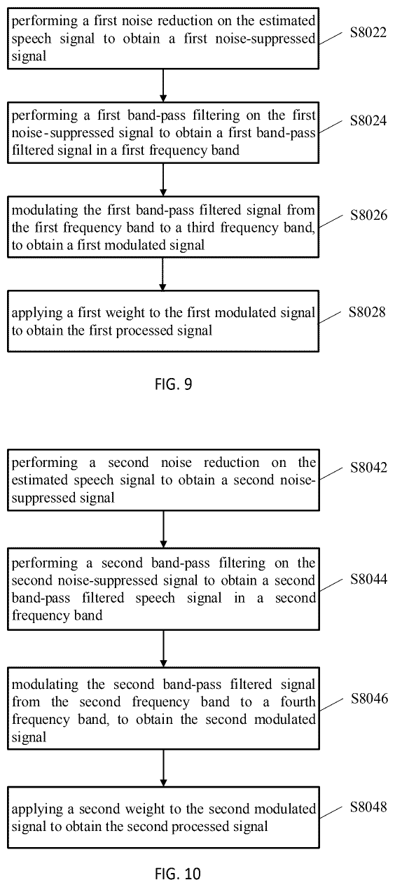

To further improve the in-ear signal enhanced using the transfer function, a bandwidth expansion method may be applied. FIG. 8 illustrates a flowchart of the method for performing the excitation expansion on the estimated speech signal according to one or more embodiments of the present disclosure. At S802, a first processing may be performed on the estimated speech signal ŝ(t) to obtain a first processed signal. At S804, a second processing may be performed on the estimated speech signal ŝ(t) to obtain a first processed signal. The processes of S802 and S804 may be performed in sequence, in reverse sequence, or simultaneously, and these processes will be described in detail later with reference to FIG. 9 and FIG. 10. At S806, the first processed signal obtained in S802, the second processed signal obtained in S804 and the estimated speech signal may be added up, and a mixed signal may be generated. At S808, a first LPC filtering may be applied to the mixed signal, and the first estimated excitation signal eᵢₙ₋ₑₐᵣ(t) and first LPC coefficients aᵢₙ₋ₑₐᵣ(k) may be generated.

FIG. 9 illustrates a flowchart of the method for performing the first processing at S802 of FIG. 8 according to one or more embodiments of the present disclosure. At S8022, a first noise reduction may be performed on the estimated speech signal, and a first noise-suppressed signal may be generated. At S8024, a first band-pass filtering may be performed on the first noise-suppressed signal, and a first band-pass filtered signal with a first frequency band may be generated. At S8026, the first band-pass filtered signal may be modulated from the first frequency band to a third frequency band, and then a first modulated signal may be generated. At S8028, a first weight may be applied to the first modulated signal to output the first processed signal.

FIG. 10 illustrates a flowchart of the method for performing the second processing at S804 of FIG. 8 according to one or more embodiments of the present disclosure. At S8042, a second noise reduction may be performed on the estimated speech signal, and a second noise-suppressed signal may be generated. At S8044, a second band-pass filtering may be performed on the second noise-suppressed signal, and a second band-pass filtered signal with a second frequency band may be generated. At S8046, the second band-pass filtered signal may be modulated from the second frequency band to a fourth frequency band, and a second modulated signal may be generated. At S8048, a second weight may be applied to the second modulated signal to output the second processed signal.

Basically, the two processes of FIG. 9 and FIG. 10 aim to modulate the signal from lower frequency bands to higher frequency bands with a shifting of multiply times of a pitch frequency (F0), because an estimation of the pitch frequency is relatively easy for the in-ear signal in a good SNR. The modulations can be applied to different bands.

To expand signal components but not the noise, two noise suppression processes, i.e., the first noise reduction and the second noise reduction, are applied to the estimated speech signal ŝ(t), separately. According to one or more embodiment, the first noise reduction is configured to apply a lighter noise suppression than the second noise reduction. For example, an algorithm used in the first noise reduction may be based on Mel-frequency or Gammatone bands, which estimates the noise in different pre-defined frequency bands and applies a light suppression. The second noise reduction estimates the noise in each frequency bin and with some overestimation, wherein a width of each frequency bin is decided by a data length of Fourier transform and a sampling rate, for example. The configurations of the first and second noise reduction are based on the following: harmonic components of the speech signals received by the in-air microphone in a quiet environment become weaker with increasing frequencies; a voiced signal captured from the in-ear microphone keeps a good contexture of harmonics below 2500 or 3000 Hz, especially after being applied the transfer function, but the signal in the very low frequency band is easily contaminated by the noise; the energy of the signal at F0 (usually below 500 Hz) is relatively strong and the corresponding difference to the following band (500-1000 Hz) is quite obvious.

The processes of FIG. 9 and FIG. 10 further utilize different modulations to different frequency bands after different noise reductions. For example, the first (light) noise-suppressed speech signal may be further filtered by the first band-pass filter with a first frequency band (such as 500 to 2500 Hz), and then the first band-pass filtered signal in the first frequency band (such as 500 to 2500 Hz) may be modulated to the third frequency band (such as about 2500 to 4500 Hz), where the modulation frequency is multiple times of F0 (pitch frequency) around 2500 Hz.

For example, the second (heavy) noise-suppressed speech signal may be further filtered by the second band-pass filter with a second frequency band (such as 500 to 3500 Hz), and then the second band-pass filtered signal with the second frequency band (such as 500 to 3500 Hz) may be modulated to the fourth frequency band (such as about 4500 to 7500 Hz), where the modulation frequency is multiple times of F0 (pitch frequency) around 4500 Hz.

As described above, the mixed signal may be obtained by adding the first processed signal, the second processed signal and the estimated speech signal, after the first and second process described with reference to FIG. 9 and FIG. 10. Then, the first LPC filtering may be applied to the mixed signal, and the first estimated excitation signal eᵢₙ₋ₑₐᵣ(t) and first LPC coefficients aᵢₙ₋ₑₐᵣ(k) may be generated. Also, a second LPC filtering may be applied to the in-air speech signal (i.e., the speech signal y(t) captured by the in-air microphone), then the second estimated excitation signal eᵢₙ₋ₐᵢᵣ(t) and second LPC coefficients aᵢₙ₋ₐᵢᵣ(k) may be generated.

FIG. 11 illustrates a flowchart of a method for synthesizing or reconstructing the speech signal based on the first estimated excitation according to one or more embodiments of the present disclosure. For example, at S1102, the first LPC coefficients aᵢₙ₋ₑₐᵣ(k) and the second LPC coefficients aᵢₙ₋ₐᵢᵣ(k) may be merged to obtain new LPC coefficients. Then, at S1104, the reconstructed speech signal may be obtained by convoluting the first estimated excitation signal eᵢₙ₋ₑₐᵣ(t) with the new LPC coefficients.

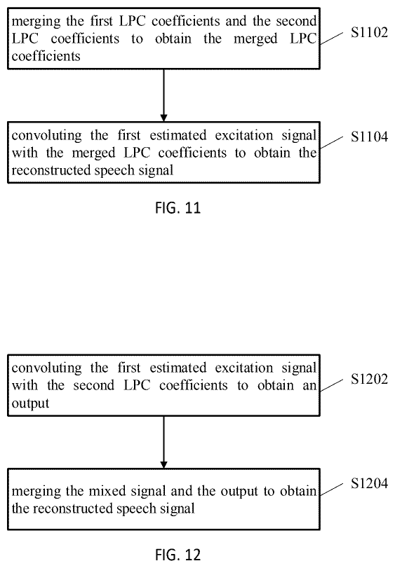

FIG. 12 illustrates a flowchart of another method for synthesizing or reconstructing the speech signal based on the first estimated excitation according to one or more embodiments of the present disclosure. For example, at S1202, the first estimated excitation signal eᵢₙ₋ₑₐᵣ(t) may be convoluted with the second LPC coefficients aᵢₙ₋ₐᵢᵣ(k) to obtain an output. Then, at S1204, the reconstructed speech signal may be obtained by merging the mixed signal in S806 and the output obtained as S1202.

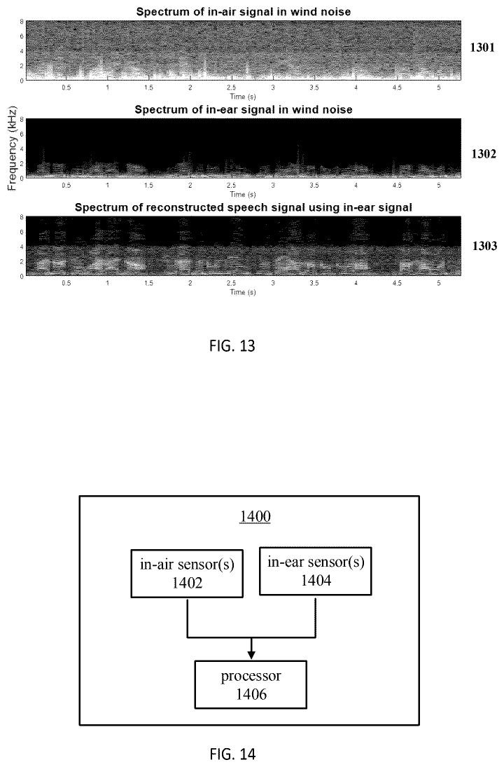

FIG. 13 illustrates examples of spectrums of a section of an in-air signal, an in-ear signal and a reconstructed speech signal in a wind noise case, using the method according to one or more embodiments described above.

In the examples illustrated in FIG. 13, a subject worn a headset device containing both in-air and in-ear sensors and spoke in wind noise environment (the wind speed is about 3 m/s). The spectrum of the signal captured by the in-air sensor is showed in the picture 1301. It can be seen from the picture 1301 that the speech signal is fully smeared by the wind noise, and thus it is hard to understand the content. The spectrum of the signal captured by the in-ear sensor is showed in the picture 1302. It can be seen from the picture 1302 that, with a much higher SNR, the speech signal is clear enough to understand. But it sounds muffled and unnatural, due to the distortion and the absence of high frequency part. Neither of the signals captured from the two channels shown in the pictures 1301 and 1302 can provide a pleasant sound of voice.

With the method proposed herein, i.e., the method of applying the transfer function and synthesizing the expanded in-ear signal, the speech signal may be reconstructed. The spectrum of the reconstructed speech signal is showed in the picture 1303. It can be seen from the picture 1303, the spectrum is recovered to have high frequency components, and thus the audio experience of the reconstructed speech signal is significantly better than the noisy in-air signal and the muffled in-ear signal.

Furthermore, a speech detection using the in-ear sensor may be used in both processes of applying the transfer function and expanding the in-ear speech signals. Since both processes perform amplification, the speech detection will help to enhance the speech only and reject the noise part.

FIG. 14 illustrates an example of a system 1400 for reconstructing speech signals, such as a headset device, according to one or more embodiments of the present disclosure. As shown in FIG. 14, the system 1400 may comprise at least one in-air sensor 1402, at least one in-ear sensor 1404 and a processor 1406. The processor 1406 may be configured to receive the in-air speech signal from at least one in-air sensor 1402 and an in-ear speech signal from at least one in-ear sensor 1404. The processor 1406 may be configured to estimate a transfer function between the in-air speech signal outputted from at least one in-air sensor 1402 and the in-ear speech signal outputted from at least one in-ear sensor 1404. The processor 1406 may be configured to obtain an estimated speech signal based on the estimated transfer function and the in-ear speech signal. The processor 1406 may be further configured to perform an excitation expansion on the estimated speech signal to obtain a first estimated excitation signal and reconstruct a speech signal based on the first estimated excitation signal.

It can be understood that the discussed method with reference to FIGS. 1-13 can be implemented by the processor 1406. The processor 1406 may be any technically feasible hardware unit configured to process data and execute software applications, including without limitation, a central processing unit (CPU), a microcontroller unit (MCU), an application specific integrated circuit (ASIC), a digital signal processor (DSP) chip and so forth.

In this disclosure, a developed method and system is provided to reconstruct in-ear speech signals with an enhanced spectrum. The developed method utilizes the advantage of high SNRs of speech signals captured by in-ear sensors, and overcomes the disadvantages of a spectrum distortion and absence of high frequency components.

The method in this disclosure adopts two key methods. The transfer function method estimates the difference between two propagation pathways. The pre-estimated transfer function can be updated for each individual wearer. The expanding and synthesis method relies on low frequency parts with a high SNR and modulates the low frequency parts to high frequency bands. The LPC residual in the artificially expanded in-ear signal is for an excitation estimation, and LPC coefficients estimated from the in-air audio sensor signals are used for estimating the envelope of the high frequency part, as noises mainly affect the low frequency parts of the in-air signal.

This disclosure provides a solution for heavy noises and some special cases, such as factories, disaster rescue and so on. The method and system disclosed herein may be used separately or potentially combined with other channels/modules, such as beamforming. Afterward, further noise suppression may be applied to the synthesized signal for a further better improvement. Different from methods in telecommunication bandwidth expansion which normally estimates the wide band spectral envelope/LPC coefficients by mapping and training, or end to end mapping in deep learning category, the method in this disclosure is low computational, as no pre-training or extensive statistics are desired.

1. In some embodiments, a method for reconstructing speech signals comprising: estimating a transfer function between an in-air speech signal and an in-ear speech signal; obtaining an estimated speech signal based on the estimated transfer function and the in-ear speech signal; performing an excitation expansion on the estimated speech signal to obtain a first estimated excitation signal; and reconstructing a speech signal based on the first estimated excitation signal.

2. The method according to clause 1, wherein the obtaining the estimated speech signal based on the estimated transfer function and the in-ear speech signal comprises: convoluting the in-ear speech signal with an impulse response of an inverse of the transfer function to obtain the estimated speech signal.

3. The method according to any one of clauses 1-2, wherein the performing the excitation expansion on the estimated speech signal to obtain the first estimated excitation signal comprises: performing a first processing on the estimated speech signal to obtain a first processed signal; performing a second processing on the estimated speech signal to obtain a second processed signal; adding the first processed signal, the second processed signal and the estimated speech signal to obtain a mixed signal; and applying a first LPC filtering to the mixed signal to output the first estimated excitation signal and first LPC coefficients.

4. The method according to any one of clauses 1-3, further comprises: applying a second LPC filtering to the in-air speech signal to output the second estimated excitation signal and second LPC coefficients.

5. The method according to any one of clauses 1-4, wherein the reconstructing the speech signal based on the first estimated excitation comprises: merging the first LPC coefficients and the second LPC coefficients to obtain the merged LPC coefficients; and convoluting the first estimated excitation signal with the merged LPC coefficients to obtain the reconstructed speech signal.

6. The method according to any one of clauses 1-5, wherein the reconstructing the speech signal based on the first estimated excitation comprises: convoluting the first estimated excitation signal with the second LPC coefficients to obtain an output; and merging the mixed signal and the output to obtain the reconstructed speech signal.

7. The method according to any one of clauses 1-6, wherein the performing the first processing on the estimated speech signal to obtain the first processed signal comprises: performing a first noise reduction on the estimated speech signal to obtain a first noise-suppressed signal; performing a first band-pass filtering on the first-noise suppressed signal to obtain a first band-pass filtered signal in a first frequency band; modulating the first band-pass filtered signal from the first frequency band to a third frequency band, to obtain a first modulated signal; and applying a first weight to the first modulated signal to obtain the first processed signal.

8. The method according to any one of clauses 1-7, wherein the performing the second processing on the estimated speech signal to obtain the second processed signal comprises: performing a second noise reduction on the estimated speech signal to obtain a second noise-suppressed signal; performing a second band-pass filtering on the second noise-suppressed signal to obtain a second band-pass filtered speech signal in a second frequency band; modulating the second band-pass filtered signal from the second frequency band to a fourth frequency band, to obtain the second modulated signal; and applying a second weight to the second modulated signal to obtain the second processed signal.

9. The method according to any one of clauses 1-8, wherein the first noise reduction is configured to apply a lighter noise suppression than the second noise reduction; wherein the first frequency band is within the second frequency band; and wherein the fourth frequency band is higher than the third frequency band.

10. The method according to any one of clauses 1-9, wherein the in-air speech signal is outputted from at least one in-air sensor and the in-ear speech signal is outputted from at least one in-ear sensor; and wherein the at least one in-air sensor and the at least one in-ear sensor are included in a headset device.

11. In some embodiments, a system for reconstructing speech signals comprising: at least one in-air sensor; at least one in-ear sensor; and a processor coupled to the at least one in-air sensor and the at least one in-ear sensor and configured to: estimate a transfer function between an in-air speech signal outputted from at least one in-air sensor and an in-ear speech signal outputted from at least one in-ear sensor; obtain an estimated speech signal based on the estimated transfer function and the in-ear speech signal; perform an excitation expansion on the estimated speech signal to obtain a first estimated excitation signal; and reconstruct a speech signal based on the first estimated excitation signal.

12. The system according to clause 11, wherein the processor is configured to convolute the in-ear speech signal with an impulse response of an inverse of the transfer function to obtain the estimated speech signal.

13. The system according to any one of clauses 11-12, wherein the processor is configured to: perform a first processing on the estimated speech signal to obtain a first processed signal; perform a second processing on the estimated speech signal to obtain a second processed signal; add the first processed signal, the second processed signal and the estimated speech signal to obtain a mixed signal; and apply a first LPC filtering to the mixed signal to output the first estimated excitation signal and first LPC coefficients.

14. The system according to any one of clauses 11-13, wherein the processor is configured to apply a second LPC filtering to the in-air speech signal to output the second estimated excitation signal and second LPC coefficients.

15. The system according to any one of clauses 11-14, wherein the processor is configured to: merge the first LPC coefficients and the second LPC coefficients to obtain the merged LPC coefficients; and convolute the first estimated excitation signal with the merged LPC coefficients to obtain the reconstructed speech signal.

16. The system according to any one of clauses 11-15, wherein the processor is configured to: convolute the first estimated excitation signal with the second LPC coefficients to obtain an output; and merge the mixed signal and the output to obtain the reconstructed speech signal.

17. The system according to any one of clauses 11-16, wherein the first processing comprises: performing a first noise reduction on the estimated speech signal to obtain a first noise-suppressed signal; performing a first band-pass filtering on the first noise-suppressed signal to obtain a first band-pass filtered signal in a first frequency band; modulating the first band-pass filtered signal from the first frequency band to a third frequency band, to obtain a first modulated signal; and applying a first weight to the first modulated signal to obtain the first processed signal.

18. The system according to any one of clauses 11-17, wherein the second processing comprises: performing a second noise reduction on the estimated speech signal to obtain a second noise-suppressed signal; performing a second band-pass filtering on the second noise-suppressed signal to obtain a second band-pass filtered speech signal in a second frequency band; modulating the second band-pass filtered signal from the second frequency band to a fourth frequency band, to obtain the second modulated signal; and applying a second weight to the second modulated signal to obtain the second processed signal.

19. The system according to any one of clauses 11-18, wherein the first noise reduction is configured to apply a lighter suppression than the second noise reduction; wherein the first frequency band is within the second frequency band; and wherein the fourth frequency band is higher than the third frequency band.

20. In some embodiments, a computer-readable storage medium comprising computer-executable instructions which, when executed by a computer, causes the computer to perform the method according to any one of clauses 1-10.

The descriptions of the various embodiments have been presented for purposes of illustration, but are not intended to be exhaustive or limited to the embodiments disclosed. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.”

As used in this disclosure, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective calculating/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the drawings illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for reconstructing speech signals, the method comprising:
estimating a transfer function between an in-air speech signal and an in-ear speech signal;
obtaining an estimated speech signal based on the estimated transfer function and the in-ear speech signal;
performing an excitation expansion on the estimated speech signal to obtain a first estimated excitation signal; and
reconstructing a speech signal based on the first estimated excitation signal.

2. The method of claim 1, wherein the obtaining the estimated speech signal comprises:
convoluting the in-ear speech signal with an impulse response of an inverse of the estimated transfer function to obtain the estimated speech signal.

3. The method of claim 1, wherein performing the excitation expansion on the estimated speech signal comprises:
performing a first processing on the estimated speech signal to obtain a first processed signal;
performing a second processing on the estimated speech signal to obtain a second processed signal;
adding the first processed signal, the second processed signal and the estimated speech signal to obtain a mixed signal; and
applying a first LPC filtering to the mixed signal to output the first estimated excitation signal and first LPC coefficients.

4. The method of claim 1, further comprises:
applying a second LPC filtering to the in-air speech signal to output a second estimated excitation signal and second LPC coefficients.

5. The method according of claim 3, wherein the reconstructing the speech comprises:
merging the first LPC coefficients and second LPC coefficients to obtain the merged LPC coefficients; and
convoluting the first estimated excitation signal with the merged LPC coefficients to obtain the reconstructed speech signal.

6. The method of claim 3, wherein the reconstructing the speech signal comprises:
convoluting the first estimated excitation signal with the second LPC coefficients to obtain an output; and
merging the mixed signal and the output to obtain the reconstructed speech signal.

7. The method of claim 3, wherein the performing the first processing on the estimated speech signal comprises:
performing a first noise-reduction on the estimated speech signal to obtain a first noise-suppressed signal;
performing a first band-pass filtering on the first noise-suppressed signal to obtain a first band-pass filtered signal in a first frequency band;
modulating the first band-pass filtered signal from the first frequency band to a third frequency band to obtain a first modulated signal; and
applying a first weight to the first modulated signal to obtain the first processed signal.

8. The method of claim 7, wherein performing the second processing on the estimated speech signal comprises:
performing a second noise-reduction on the estimated speech signal to obtain a second noise-suppressed signal;
performing a second band-pass filtering on the second noise-suppressed signal to obtain a second band-pass filtered speech signal in a second frequency band;
modulating the second band-pass filtered signal from the second frequency band to a fourth frequency band to obtain the second modulated signal; and
applying a second weight to the second modulated signal to obtain the second processed signal.

9. The method of claim 8, wherein the first noise-reduction is configured to apply a lighter noise suppression than the second noise-reduction;
wherein the first frequency band is within the second frequency band; and
wherein the fourth frequency band is higher than the third frequency band.

10. The method of claim 1,
wherein the in-air speech signal is outputted from at least one in-air sensor and the in-ear speech signal is outputted from at least one in-ear sensor; and
wherein the at least one in-air sensor and the at least one in-ear sensor are included in a headset device.

11. A system for reconstructing speech signals, the system comprising:
at least one in-air sensor;
at least one in-ear sensor; and
a processor coupled to the at least one in-air sensor and the at least one in-ear sensor and configured to:
estimate a transfer function between an in-air speech signal outputted from the at least one in-air sensor and an in-ear speech signal outputted from the at least one in-ear sensor;
obtain an estimated speech signal based on the estimated transfer function and the in-ear speech signal;
perform an excitation expansion on the estimated speech signal to obtain a first estimated excitation signal; and
reconstruct a speech signal based on the first estimated excitation signal.

12. The system of claim 11, wherein the processor is configured to convolute the in-ear speech signal with an impulse response of an inverse of the estimated transfer function to obtain the estimated speech signal.

13. The system of claim 11, wherein the processor is configured to:
perform a first processing on the estimated speech signal to obtain a first processed signal;
perform a second processing on the estimated speech signal to obtain a second processed signal;
add the first processed signal, the second processed signal and the estimated speech signal to obtain a mixed signal; and
apply a first LPC filtering to the mixed signal to output the first estimated excitation signal and first LPC coefficients.

14. The system of claim 11, wherein the processor is configured to apply a second LPC filtering to the in-air speech signal to output a second estimated excitation signal and second LPC coefficients.

15. The system of claim 13, wherein the processor is configured to:
merge the first LPC coefficients and second LPC coefficients to obtain the merged LPC coefficients; and
convolute the first estimated excitation signal with the merged LPC coefficients to obtain the reconstructed speech signal.

16. The system of claim 13, wherein the processor is configured to:
convolute the first estimated excitation signal with second LPC coefficients to obtain an output; and
merge the mixed signal and the output to obtain the reconstructed speech signal.

17. The system of claim 13, wherein performance of the first processing comprises:
performing a first noise-reduction on the estimated speech signal to obtain a first noise-suppressed signal;
performing a first band-pass filtering on the first noise-suppressed signal to obtain a first band-pass filtered signal in a first frequency band;
modulating the first band-pass filtered signal from the first frequency band to a third frequency band, to obtain a first modulated signal; and
applying a first weight to the first modulated signal to obtain the first processed signal.

18. The system of claim 17, wherein performance of the second processing comprises:
performing a second noise-reduction on the estimated speech signal to obtain a second noise-suppressed signal;
performing a second band-pass filtering on the second noise-suppressed signal to obtain a second band-pass filtered speech signal in a second frequency band;
modulating the second band-pass filtered signal from the second frequency band to a fourth frequency band, to obtain the second modulated signal; and
applying a second weight to the second modulated signal to obtain the second processed signal.

19. The system of claim 18,
wherein the first noise-reduction is configured to apply a lighter suppression than the second noise-reduction;
wherein the first frequency band is within the second frequency band; and
wherein the fourth frequency band is higher than the third frequency band.

20. One or more non-transitory computer-readable media storing processor-executable instructions that, when executed by at least one processor, cause the at least one processor to:
estimate a transfer function between an in-air speech signal and an in-ear speech signal;
obtain an estimated speech signal based on the estimated transfer function and the in-ear speech signal;
perform an excitation expansion on the estimated speech signal to obtain a first estimated excitation signal; and
reconstruct a speech signal based on the first estimated excitation signal.
